(19) United States
(12) Patent Application Publication
(10) Pub. No.: US 2013/0092265 A1
(43) Pub. Date: Apr. 18, 2013

(54) ROTARY PADDLE LIMIT SWITCH AND METHOD FOR OPERATING A ROTARY PADDLE LIMIT SWITCH

(71) Applicants: Marc Stahl, Wiggensbach (DE); Robert Zeller, Lechbruck (DE); Detlef Schuttenberg, Kaufbeuren (DE); Rainer Pöllath, Ruckholz (DE); Angelika Heim, Pfronten (DE)

(72) Inventors: Marc Stahl, Wiggensbach (DE); Robert Zeller, Lechbruck (DE); Detlef Schuttenberg, Kaufbeuren (DE); Rainer Pöllath, Ruckholz (DE); Angelika Heim, Pfronten (DE)

(73) Assignee: Endress + Hauser Wetzer GmbH + Co. KG, Nesselwang (DE)

(21) Appl. No.: 13/615,924

(22) Filed: Sep. 14, 2012

Related U.S. Application Data
(60) Provisional application No. 61/627,570, filed on Oct. 14, 2011.

(30) Foreign Application Priority Data
Oct. 14, 2011 (DE) 10 2011 084 561.5

(51) Int. Cl. F16K 37/00

(52) U.S. Cl. 137/558

(57) ABSTRACT

A rotary paddle limit switch for determining a limit level of a fill substance, comprising a housing, which serves for accommodating a motor and a drive shaft. The drive shaft serves for rotation of a rotary paddle secured on the drive shaft, wherein the rotary paddle limit switch has a viewing window for optically checking rotational movement of the rotary paddle and/or the drive shaft.

### CROSS-REFERENCE TO RELATED APPLICATION

This application is a Nonprovisional which claims the benefit of U.S. Provisional Application 61/627,570, filed on Oct. 14, 2011.

### TECHNICAL FIELD

The invention relates to a rotary paddle limit switch for determining a limit level of a fill substance. The rotary paddle limit switch includes a housing, which serves for accommodating a motor and a drive shaft, wherein the drive shaft serves for rotation of a rotary paddle secured on the drive shaft.

### BACKGROUND DISCUSSION

In industrial applications, the liquids and bulk goods required for manufacture of certain products are frequently stored in containments, for instance, containers such as silos. In order to monitor the amount of material on hand, most often, so called limit level switches are applied, which, upon the reaching of the fill level to be monitored, produce a signal. For example, such limit level switches are used for producing an alarm signal upon the reaching of a maximum fill level, so that the container does not overflow.

Various measuring devices are known for monitoring a predetermined fill level of a bulk good in a container. The present invention relates to a rotary paddle limit switch. This operation of such a device rests on following principle:

Via a drive shaft, a motor causes a measuring paddle to rotate. The measuring paddle is located in the container. If the substance, such as a bulk good, is filled sufficiently into the container that it comes into contact with the measuring paddle, this retards the rotary movement of the measuring paddle. The measuring paddle slows down or even completely stops rotating. The motor transfers from an idling state to a switched off state, i.e. the electrical current supply of the motor is interrupted and the rotational movement of the measuring paddle stops. As soon as the fill substance sinks away from the measuring paddle, the measuring paddle begins to rotate again. Furthermore, when the fill substance contacts the measuring paddle, a switch contact is closed, which signals the user that the fill level has been reached. Such measuring devices are available from the assignee under the mark Soliswitch.

Due to the compact and often closed (i.e. not permitting viewing) manner of construction of rotary paddle measuring devices, or of the containment, on which the rotary paddle limit switch is applied, an optical, and therewith direct, state- and/or function checking is scarcely possible or possible only with great effort.

### SUMMARY OF THE INVENTION

An object of the invention is to provide a simple optical checking of the state and/or the functional ability of a rotary paddle limit switch.

The object is achieved according to the invention by a rotary paddle limit switch, by an arrangement comprising a rotary paddle limit switch, and by a method for function checking of a rotary paddle limit switch.

As regards the rotary paddle limit switch, the object is achieved by features including that the rotary paddle limit switch has a viewing window for optical checking of the rotational movement of the rotary paddle and/or the drive shaft.

The present invention relates thus to a rotary paddle limit switch, which has a viewing window, for example, under a lid, which can be screwed off, so that the rotational movement of a display disk can be observed through the viewing window. The viewing window can, however, also extend through the housing of the rotary paddle limit switch. For example, a region of the housing or the lid can be embodied transparently for this purpose. Arranged in the housing of the rotary paddle limit switch are, for example, an operating electronics, the motor and/or the shaft. In such case, the drive unit of the rotary paddle limit switch composed of operating electronics, motor and/or shaft is arranged in such a manner that a line of sight onto the display disk is provided through the viewing window.

In a form of embodiment of the rotary paddle limit switch, the housing of the rotary paddle limit switch includes a removable lid, which is composed of a transparent material and/or in which the viewing window is located.

In an additional form of embodiment of the rotary paddle limit switch, an display element is provided, especially a display disk, which is preferably circular, which is operatively connected with the drive shaft and which serves to indicate rotational movement of the drive shaft and/or the rotary paddle.

In an additional form of embodiment of the rotary paddle limit switch, the display element is oriented perpendicularly to the drive shaft and the display element is preferably connected centrally with the drive shaft.

The display disk can be, for example, a circularly round display washer, which centrally receives the drive shaft preferably rigidly connected with it and which thereby follows the rotational movement of the drive shaft of the rotary paddle limit switch.

In an additional form of embodiment of the rotary paddle limit switch, the display element has a functionalized surface, preferably a surface facing toward the viewing window, especially a surface equipped with markings, wherein the surface serves to indicate, especially by color change, the rotational movement of the drive shaft and/or the rotary paddle.

The display disk surface, equipped with markings and facing toward the viewing window, respectively visible through the viewing window, can be illuminated, for example, by a light source. The light source can be a white LED unit driven with an appropriate voltage supply connected with grid voltage, e.g. 240 VAC.

The markings on the display disk can be, for example, in the form of an alternating pattern, such as a black and white, zebra like pattern. These markings can be matched to the RPM of the drive shaft, for example the nominal RPM of the drive shaft, for example 1 RPM (revolution per minute). Preferably, the markings are so designed that, at this nominal RPM, which is made constant by a synchronous motor coupled with a speed reduction transmission, an observer sees a uniform alternating of the zones of the pattern. In this way, a blocking, retarding or stopping of the drive shaft or the rotary paddle, such as can result, for example, at start-up of the rotary paddle limit switch, or from a loss of grid voltage, from a disturbance in the frequency of the grid voltage or from the desired drive stoppage in the case of fill level attainment, can be recognized, without having to de-install the rotary paddle limit switch or otherwise take it out of operation.

The viewing window can also be located below a removable covering, wherein the covering can be removed, without having to interrupt the functioning of the rotary paddle limit switch.

In an additional form of embodiment of the rotary paddle limit switch, a light source is provided, which preferably is arranged together with the display element within the housing of the rotary paddle limit switch, and which serves to illuminate the display element.

In an additional form of embodiment of the rotary paddle limit switch, the display element and the RPM of the drive shaft and/or the rotary paddle are matched to one another, in order to enable/to execute a sight checking of the rotational movement through the viewing window.

In an additional form of embodiment of the rotary paddle limit switch, the sight checking through the viewing window serves for detecting a blocking, retarding or stopping of the drive shaft and/or the rotary paddle.

In an additional form of embodiment of the rotary paddle limit switch, the sight checking through the viewing window serves for detecting a malfunctioning of the rotary paddle limit switch, for example, a failure of its energy supply, and preferably to indicate such by a blinking of the light source.

In an additional form of embodiment of the rotary paddle limit switch, the sight checking through the viewing window serves for detecting a disturbance, especially in the frequency, of the rotational movement of the drive shaft and/or ₜhe rotary paddle.

In an additional form of embodiment of the rotary paddle limit switch, the rotary paddle is arranged in the region of an end of the drive shaft and the display element is arranged in the region of the oppositely lying end of the drive shaft.

In an additional form of embodiment of the rotary paddle limit switch, the viewing window and the display element are arranged in such a manner that a sight checking is performable only in the direction of an axis, e.g. essentially parallel to the longitudinal axis of the drive shaft.

As regards the arrangement, the object is achieved by features including that the arrangement includes a rotary paddle limit switch according to one of the aforementioned forms of embodiment, wherein the rotary paddle limit switch is mounted on a container serving for accommodating the fill substance.

As regards the method, the object is achieved by features including that a state of the rotary paddle limit switch is determined through the viewing window based on an optical sight checking, preferably for the rotational movement of the display element.

### BRIEF DESCRIPTION OF THE DRAWINGS

The invention will now be explained in greater detail based on the appended drawing, the figures of which show as follows:

FIG. 1 is a schematic representation of a longitudinal section through a rotary paddle limit switch;

FIG. 2 is a schematic representation of a plan view onto a rotary paddle limit switch with a transparent lid; and

FIG. 3 is a schematic representation of a plan view onto a rotary paddle limit switch with a transparent lid and a therebehind lying covering with a viewing window.

### DETAILED DESCRIPTION IN CONJUNCTION WITH THE DRAWINGS

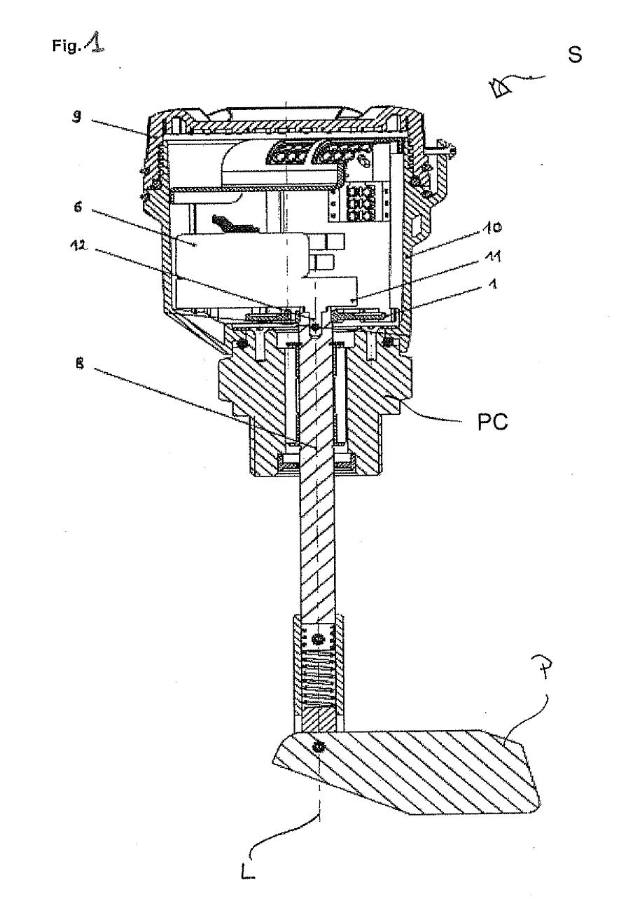

FIG. 1 shows a longitudinal section through a rotary paddle limit switch S. The rotary paddle limit switch S is composed of a housing with a basic housing part 10 and a housing lid 9. Arranged in the housing is a synchronous motor 6, which, via a transmission 11 with a transmission output 12, drives, i.e. causes to rotate, a drive shaft 8. (Synchronous-)motor and transmission form, in such case, a drive unit. A rotary paddle P can be mounted on the end of the drive shaft 8 outside of the housing. Rotation of the drive shaft 8 causes the rotary paddle P to rotate.

Further associated with the housing is a process connection PC, which serves for securement of the rotary paddle limit switch S to a container, such as, for example, a tank. The drive shaft 8 passes through the process connection PC to connect with the motor 6, more exactly with the output of the transmission 11.

Also connected with the drive shaft 8 within the housing is a display disk 2. The synchronous motor 6 and/or other components, which form the drive unit of the rotary paddle limit switch, are, in such case, so arranged that a line of sight is provided, free of obstruction, onto the display disk 2 through a viewing window 7. The viewing window 7 can, in such case, be formed by an opening in the housing lid 9, for example, in the form of a transparent window, or by a completely transparent housing lid 9. The thereby formed line of sight lies in FIG. 1, in such case, essentially parallel to the longitudinal axis L of the drive shaft 8.

In the form of embodiment shown in FIG. 1, transmission output 12 is received in a socket in the drive shaft 8, such that the rotational movement of the transmission output 12 is transmitted to the drive shaft 8. The transmission output 12 and the socket can be bolted or pinned together, if desired. The drive shaft 8 extends from its connection with the transmission output 12 out of the housing. The display disk 2 is connected with the part of drive shaft 8 within the housing. Especially, the display disk 2 is arranged on the, drive shaft 8, and/or secured with the drive shaft 8, in a region in which the transmission output 12 and the drive shaft overlap, and is, especially preferably, perpendicular both to the drive shaft 8 as well as also to the axis of the transmission output 12.

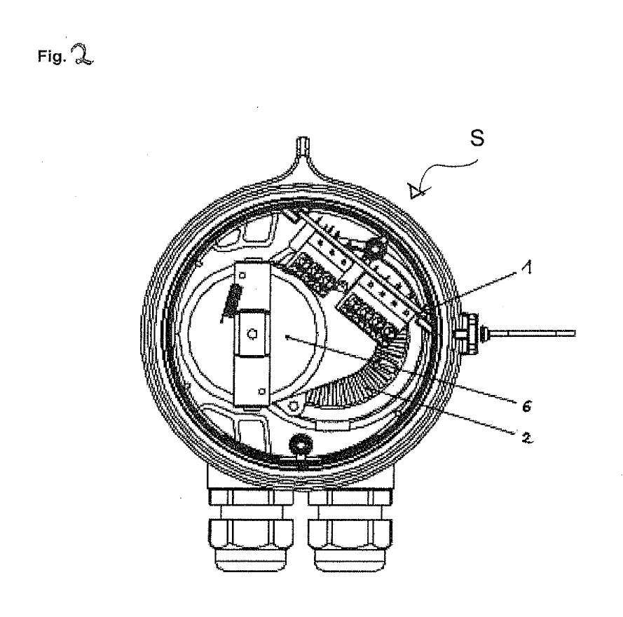

FIG. 2 shows a plan view onto a rotary paddle limit switch S equipped with a transparent housing lid 9. Alternatively to the embodiment shown in FIG. 2, a line of sight onto the display disk 2, or a greater line of sight onto the display disk 2, can be opened through the viewing window only after first removing the housing lid 9. In the example of an embodiment shown in FIG. 2, the display disk 2 has segments of different color. In FIG. 2, these are black and white alternating stripes. Additionally, the stripes are laterally offset relative to one another.

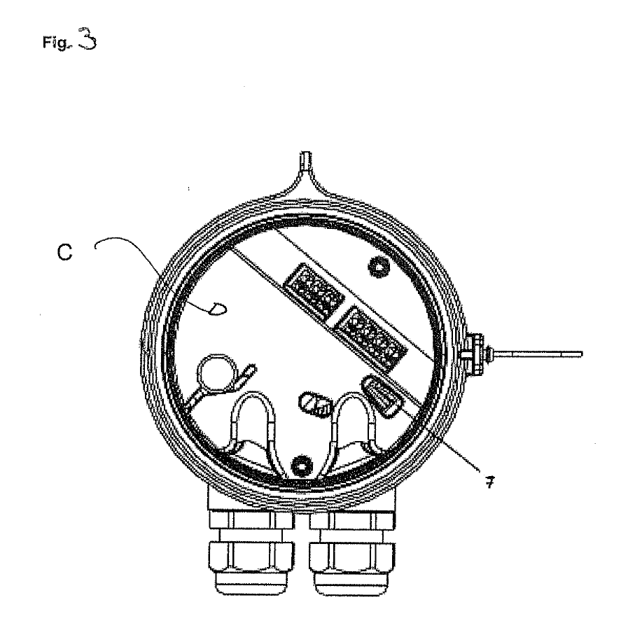

FIG. 3 shows a plan view onto a rotary paddle limit switch S also having a transparent housing lid. Provided between the housing lid and the drive unit of the rotary paddle limit switch arranged in the basic housing part is a covering C. Provided in the covering C is an opening, which serves as a viewing window 7, and which enables a view, for example, in the form of a line of sight, onto the proposed display disk 2. Thus, the display disk 2 is visible through the housing lid and the viewing window 7 for an optical checking of the rotational movement of the drive shaft and/or the rotary paddle. The covering in FIG. 3 can, furthermore, have other openings serving for accommodating, for example, motor connection terminals, etc.

Alternatively, the housing lid 9 can be made of a non-transparent material (not shown), and a transparent viewing window 7 provided in the housing lid. This viewing window of such a housing lid likewise enables a function checking of the rotational movement of the drive shaft 8 by observation of the display disk 2. The line of sight onto the display disk 2 extends, in such case, through the viewing window 7 and/or through a corresponding cutout in a circuit board, on which an operating electronics is arranged, and/or laterally past the synchronous motor 6.

In the shown forms of embodiment, the drive unit of the rotary paddle limit switch is arranged between the display disk and the housing lid and, in given cases, a covering. However, other arrangements are also possible.

1. A rotary paddle limit switch for determining a limit-level of a fill substance, comprising:
housing, which serves for accommodating a motor and a drive shaft, wherein:
said drive shaft serves for rotation of a rotary paddle secured on said drive shaft; and
the rotary paddle limit switch has a viewing window for optically checking rotational movement of said rotary paddle and/or said drive shaft.

2. The rotary paddle limit switch as claimed in claim 1, wherein:
said housing of the rotary paddle limit switch includes a removable lid, which is composed of a transparent material and/or in which said viewing window is located.

3. The rotary paddle limit switch as claimed in claim 1, further comprising:
a display element, especially a display disk, which is preferably circular, which is operatively connected with said drive shaft and which serves to indicate rotational movement of said drive shaft and/or said rotary paddle.

4. The rotary paddle limit switch as claimed in claim 3, wherein:
said display element is oriented perpendicularly to said drive shaft and said display element is preferably connected centrally with said drive shaft.

5. The rotary paddle limit switch as claimed in claim 3, wherein:
said display element has a functionalized surface, preferably a surface facing toward said viewing window, especially a surface equipped with markings; and
said surface serves to indicate, especially by color change, rotational movement of said drive shaft and/or said rotary paddle.

6. The rotary paddle limit switch as claimed in claim 3, further comprising:
a light source, which is arranged preferably together with said display element within said housing of the rotary paddle limit switch and which serves to illuminate said display element.

7. The rotary paddle limit switch as claimed in claim 3, wherein:
said display element and the RPM of said drive shaft and/or said rotary paddle are matched to one another, in order to enable/to execute a sight checking of rotational movement through said viewing window.

8. The rotary paddle limit switch as claimed in claim 1, wherein:
the sight checking through the viewing window serves for detecting a blocking, retarding or stopping of said drive shaft and/or said rotary paddle.

9. The rotary paddle limit switch as claimed in claim 1, wherein:
the sight checking through said viewing window serves for detecting, a malfunctioning of the rotary paddle limit switch, for example, a failure of its energy supply.

10. The rotary paddle limit switch as claimed in claim 1, wherein:
the sight checking through said viewing window serves for detecting a disturbance, especially in the frequency, of the rotational movement of said drive shaft and/or said rotary paddle.

11. The rotary paddle limit switch as claimed in claim 1, wherein:
said rotary paddle is arranged in the region of an end of said drive shaft; and
said display element is arranged in said housing in the region of the oppositely lying end of said drive shaft.

12. The rotary paddle limit switch as claimed in claim 3, wherein:
said viewing window and said display element are arranged in such a manner that a sight checking is performable only in the direction of an axis, e.g. essentially parallel to the longitudinal axis of said drive shaft.

13. An arrangement comprising a rotary paddle limit switch including a rotary paddle limit switch for determining a limit-level of a fill substance, comprising:
housing, which serves for accommodating a motor and a drive shaft, wherein:
said drive shaft serves for rotation of a rotary paddle secured on said drive shaft; and
the rotary paddle limit switch has a viewing window for optically checking rotational movement of said rotary paddle and/or said drive shaft, wherein:
said rotary paddle limit switch is mounted on a container serving for accommodating the fill substance.

14. A method for function checking a rotary paddle limit switch including a rotary paddle limit switch for determining a limit-level of a fill substance, comprising:
housing, which serves for accommodating a motor and a drive shaft, wherein:
said drive shaft serves for rotation of a rotary paddle secured on said drive shaft; and
the rotary paddle limit switch has a viewing window for optically checking rotational movement of said rotary paddle and/or said drive shaft, wherein:
a state of the rotary paddle limit switch is determined through the viewing window based on an optical sight checking, preferably for rotational movement of the display element.
